(19) United States
(12) Patent Application Publication
(10) Pub. No.: US 2012/0210946 A1
(43) Pub. Date: Aug. 23, 2012

(54) ENVIRONMENTAL HOUSING FOR LAYING HENS

(76) Inventor: WILLIAM B. HILGERS, Austin, TX (US)

(21) Appl. No.: 13/385,579

(22) Filed: Oct. 22, 2010

Related U.S. Application Data
(60) Provisional application No. 61/386,217, filed on Sep. 24, 2010.

(51) Int. Cl. A01K 31/18; A01K 39/01; A01K 3/00; A01K 31/04

(52) U.S. Cl. 119/443; 119/51.01; 119/502

(57) ABSTRACT

The present invention provides an environmentally friendly housing for laying hens. A preferred embodiment includes a covered structure having perching area having a porous floor, a worm bed under the perching area in which worms feed upon the manure that falls through the porous floor, a back door for access to the worm bed, and nesting boxes for laying eggs. Some embodiments are modular and can be readily expanded in sections, with each section including the parts described above. Some embodiments include an enclosed yard area in which the hens can go outside the structure and still be safe from predators. Grain can be grown in a part of the enclosed yard, with irrigation for the grain being provided by a rainwater collection system on the roof of the structure.

### TECHNICAL FIELD OF THE INVENTION

The present invention relates to a method and apparatus for providing a living arrangement for laying hens.

### BACKGROUND OF THE INVENTION

Concern about the mass production of eggs in factory farms have resulted in increased interest in small scale egg production for local use. The recall of more than 500 million eggs in 2010 has heightened the awareness of the public of the conditions in factory farms. Moreover, there is thought to be a wide variety of nutritional value in eggs depending on the conditions under which the hens are kept. There are also health and environmental concerns that arise from raising chickens in confined areas with high population densities, requiring prophylactic use of antibiotics. Overuse of antibiotics can lead to antibiotic-resistant strains of pathogens, making it desirable to minimize the use of antibiotics. Agricultural runoff from a high density animal production is a source of pollution for water reservoirs that receive surface water drained from areas of land used for raising livestock in confined areas with high population densities. There are also ethical concerns regarding raising chickens in confined areas with high population densities. Some individuals prefer to raise their own food so that they can control how the food is produced. It is desirable, therefore, to provide a compact, environmentally sound environment for raising poultry in a small area.

### SUMMARY OF THE INVENTION

An object of the invention is to provide a natural, environmentally friendly housing for laying hens.

A preferred embodiment includes a covered laying house having a nesting area and a perching area off the floor. Manure falls from the perching area to a worm bed under the perching area. Worm casting can be collected through a door behind the perching area. Grain plants for feeding the hens is grown in a fenced area outside the housing area. Some embodiments incorporate a rain collection system to provide water to irrigate the grain plants. Some embodiments are modular and can be readily expanded in sections.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows an overhead view of a chicken garden in accordance with a preferred embodiment of the present invention;

FIG. 2 shows an exploded view of a preferred embodiment of a laying house of the present invention;

FIG. 3 shows an elevation view a preferred embodiment of a laying house of the present invention;

FIG. 4 shows an overhead view of an expandable chicken garden in accordance with the present invention;

FIG. 5 shows a schematic diagram of an irrigation system using water and electric utility service in accordance with the present invention;

FIG. 6 shows a schematic diagram of an irrigation system using water utility service and a renewable energy source in accordance with the present invention;

FIG. 7 shows a schematic diagram of an irrigation system using a rainwater collection tank and electric utility service in accordance with the present invention; and

FIG. 8 shows a schematic diagram of an irrigation system using a rainwater collection tank and a renewable energy source in accordance with the present invention.

### DETAILED DESCRIPTION OF PREFERRED EMBODIMENTS

A preferred embodiment of the invention uses provides a healthy environment for laying hens to produce nutritious eggs. Preferred embodiments are compact and can be used in areas, such as urban and suburban areas.

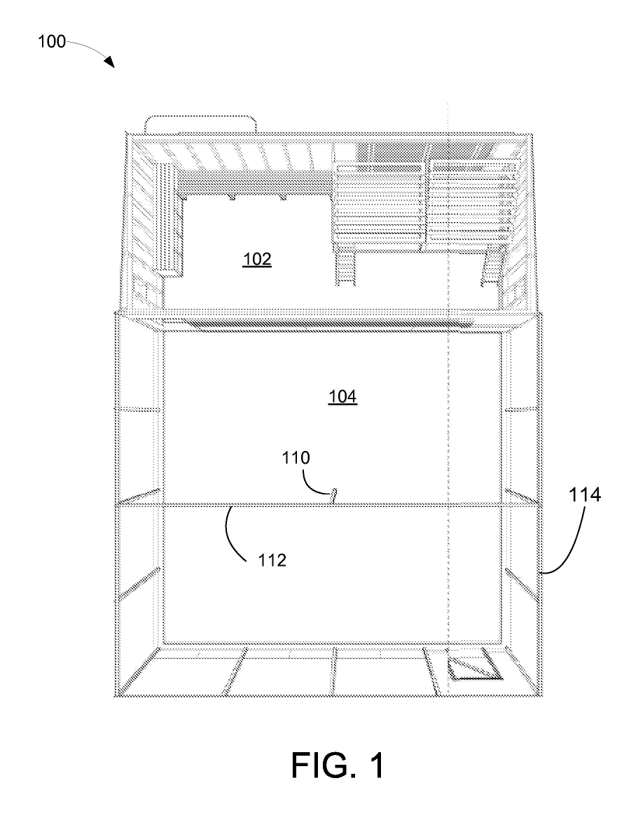

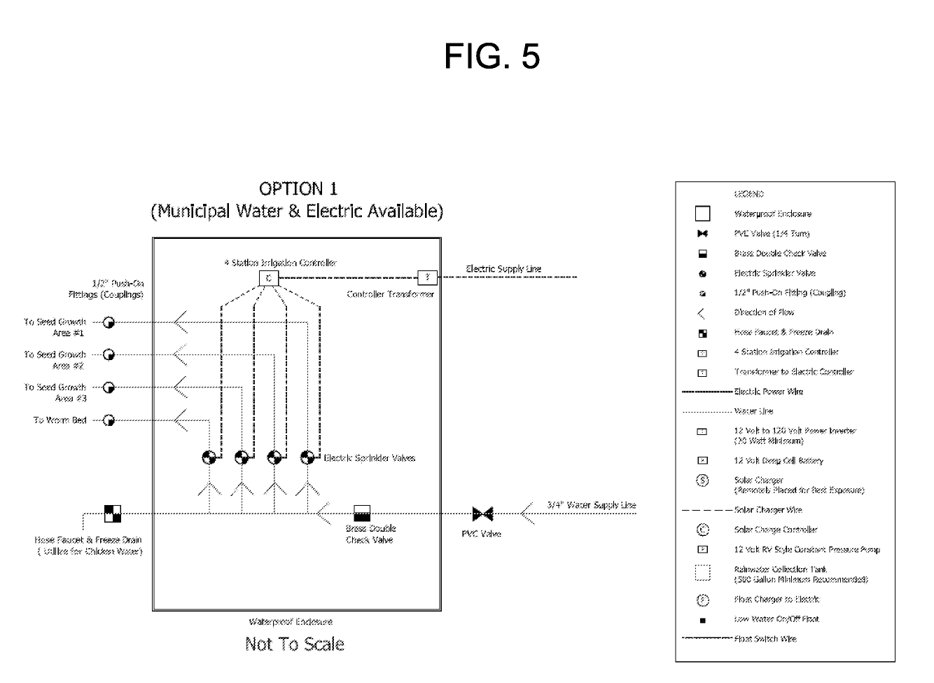

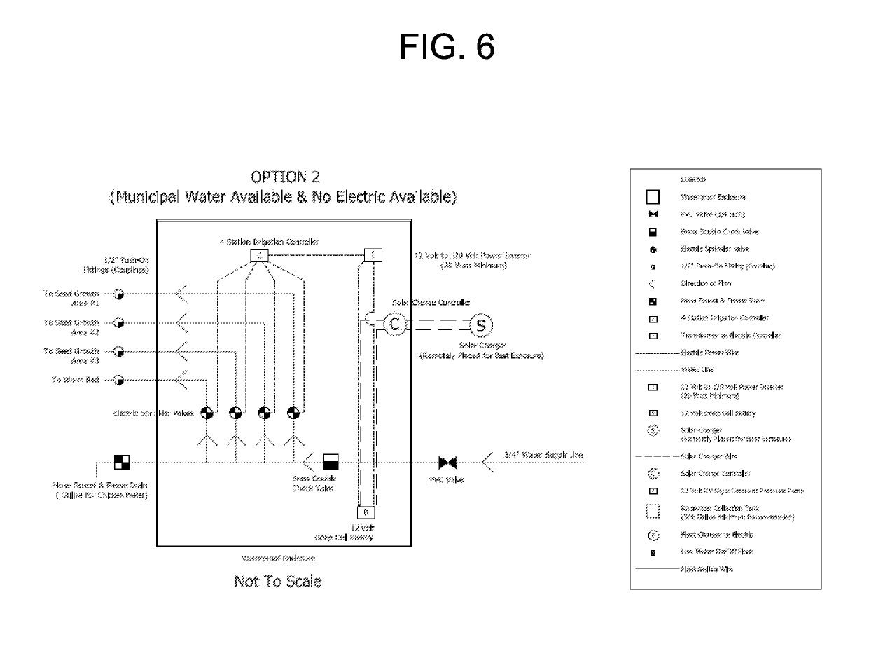

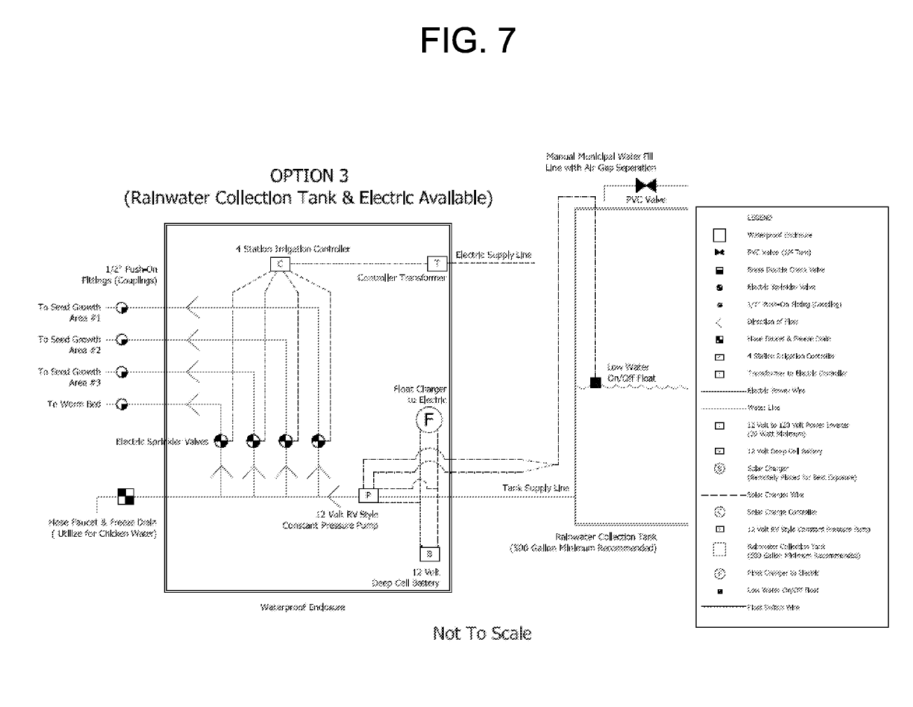

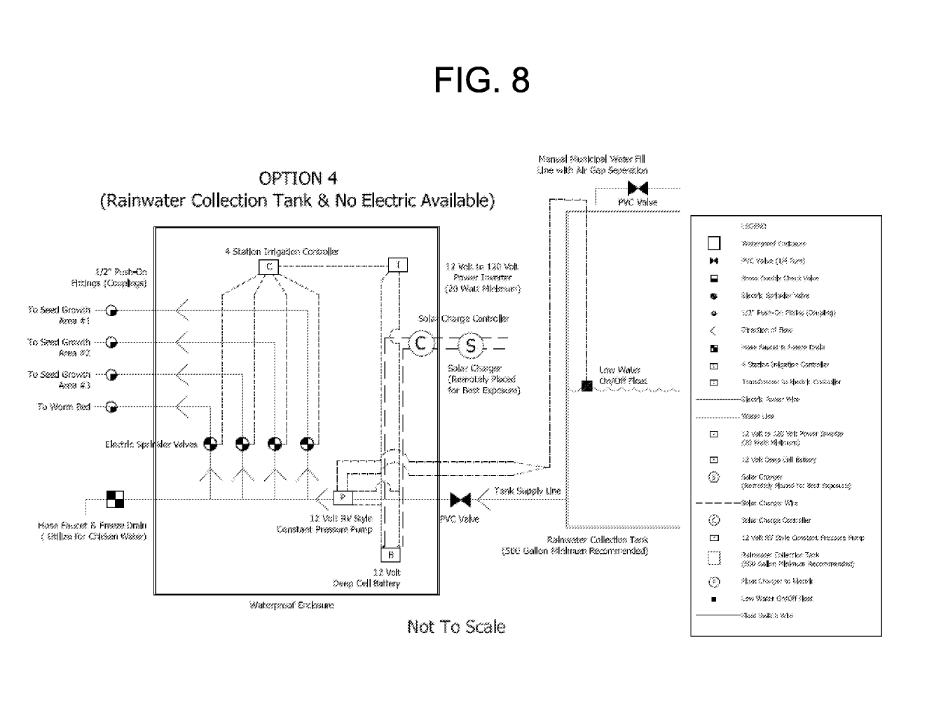

FIG. 1 shows an overhead view preferred chicken garden 100 embodying the present invention. Chicken garden 100 includes a laying house 102 and a garden area 104. Laying house 102 protects chickens from sun, rain, wind, and extreme temperatures. Garden area 104 can be planted with grain, such as such as millet or flax, which is believed to improve the nutritional quality of the eggs. An irrigation system provides water for the plants grown in garden area 104. Water for the irrigation system can be provided by a water utility service (see FIGS. 5-6). Water for the irrigation system can also be provided by a rainwater collection system that collects water from the roof of laying house 102 and stores the rainwater in a tank (see FIGS. 7-8). Power for the irrigation system can be supplied by an electric utility service (see FIG. 5 and FIG. 7). Power for the irrigation system can also be supplied by renewable energy source, such as electricity stored in a battery system that is charged by a solar charger (see FIG. 6 and FIG. 8).

Garden area 104 is surrounded by frame 114 that supports fencing, such as a wire mesh, that keeps predators out of chicken garden 100. A vertical center support 110 supports a cross-bar 112 that in turn provides additional support to frame 114. For a smaller chicken garden, center support 110 and cross bar 112 may be unnecessary, whereas for a larger chicken garden, additional center supports and cross bars may be required.

Laying house 102 may be, for example, 12 feet wide by 24 feet long. Garden area 104 may be, for example, 24 feet by 24 feet. The dimensions provided only for purposes of illustrating an exemplary embodiment and in no way limit the invention to an embodiment having only those dimensions. Preferred embodiments are compact enough to be used in a large urban or suburban lot, as well as in rural areas.

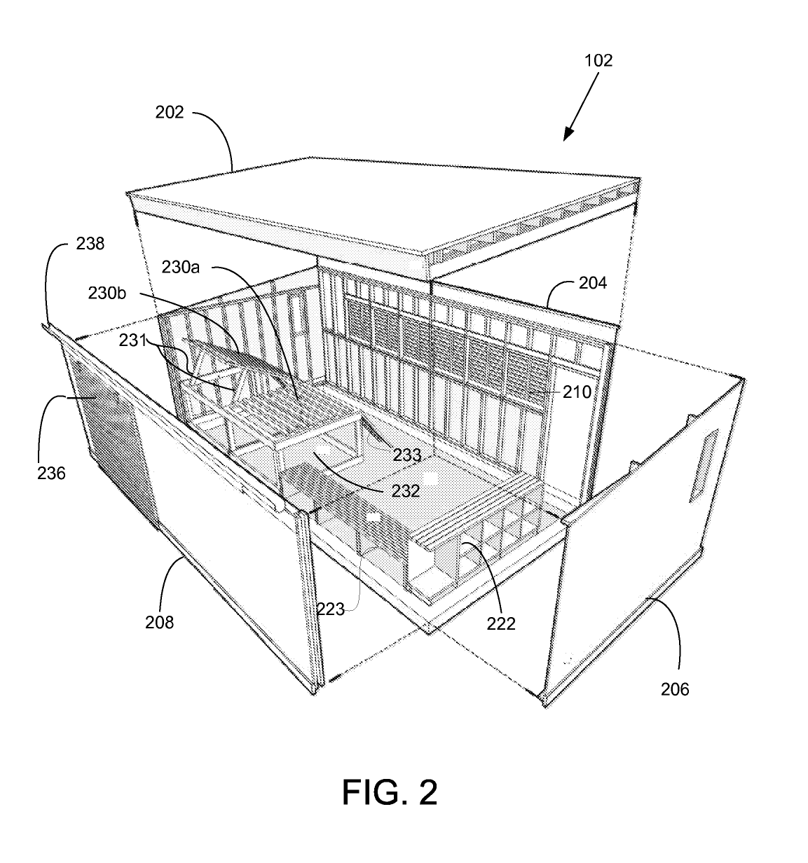

FIG. 2 shows an exploded view of a preferred embodiment of a laying house 102. The outer structure of laying house 102 includes a roof 202, front wall 204, and side walls 206. The walls can be constructed using any construction technique, such as wood or metal stud construction. The roof similarly can be constructed using any available construction technique and materials. Front wall 204 preferably includes a shutter 210 that allows the ventilation of laying house 200 to be adjusted depending on the weather and the number of hens present.

Inside laying house 102 are nesting boxes 222 and perching surfaces 230a and 230b. Nesting boxes 222 provides hens a place to lay their eggs. While shown on the floor, nesting boxes 222 are preferably positioned on a bench 223. The top of nesting boxes 222 is preferably tilted to prevent hens from perching on the top and to facilitate keeping it clean. Perching surfaces 230a and 230b provide hens a place to perch above the ground. Perching surfaces 230a and 230b are porous, that is, a constructed so that manure will fall through to worm bed 232. In the embodiment shown, perching surfaces 230a and 230b are made of slats. Perching surfaces can be flat as shown by perching surface 230a or slanted as shown by perching surface 230b. Supports 231 may be locked into different mating structures on the bottom of perching surfaces 230 to allow changing the angle of the perching surface. A ladder 233 allows hens to climb up to perching areas 230a and 230b. Below perching surfaces 230a and 230b is a worm bed 232.

Manure from chickens roosting on perching surfaces 230a and 230b fall into worm bed 232, which is located underneath perching surfaces 230a and 230b. Worms in worm bed 232 digest the manure and produce worm castings. The worm castings are highly desirable as plant fertilizer and can be used to fertilize plants cultivated in garden area 104 or elsewhere. Door 236 in back wall 208 provides access to worm bed 232 to remove the worm castings. Door 236 may be a sliding door, a hinged door, or other type of closable opening to provide easy access to worm bed 232. Gutter 238 collects rain water that falls on roof 202 and directs the rain water into a water collection tank such as a rain barrel (not shown).

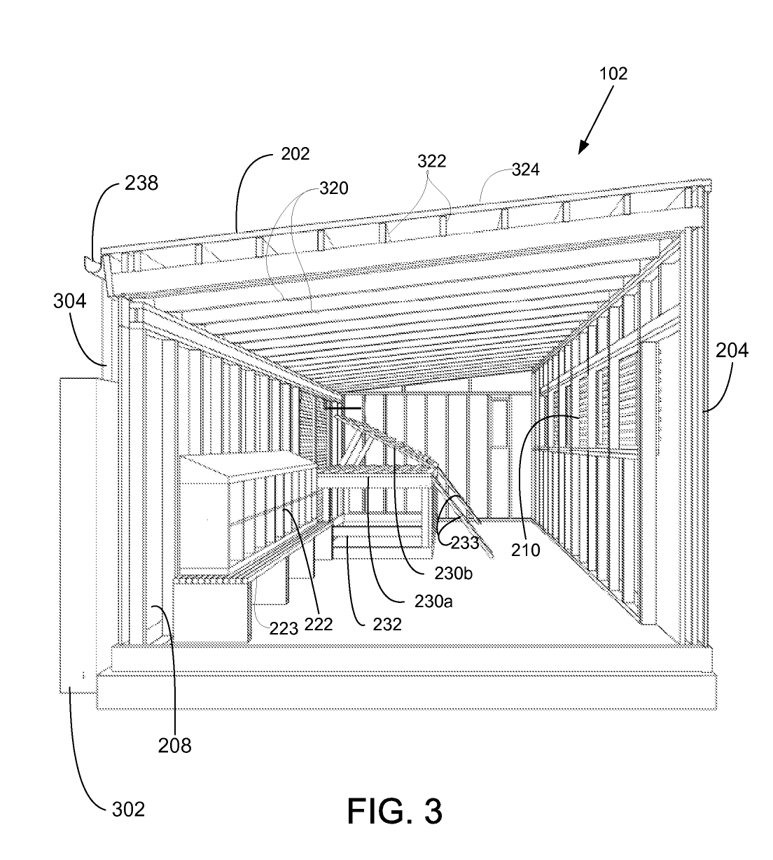

FIG. 3 shows an elevation view a preferred embodiment of laying house 102 of the present invention. Side wall 206 is not shown in FIG. 3 so that the interior of laying house 102 can be seen. Nesting boxes 222 are shown resting on bench 223. Gutter 238 collects rain water from roof 202 and directs the rain water into downspout 304, which in turn directs the rain water into water collection tank 302. Water in water collection tank 302 can be used to irrigate plants cultivated in garden area 104. FIG. 3 shows a preferred roof constructions comprises ceiling joists 320 spanning between front wall 204 and rear wall 208. Cross supports 322 are supported by joist 320 and in turn support a roof surface which can comprise, for example, corrugated metal roofing, plastic roofing, or plywood decking covered with roll roofing.

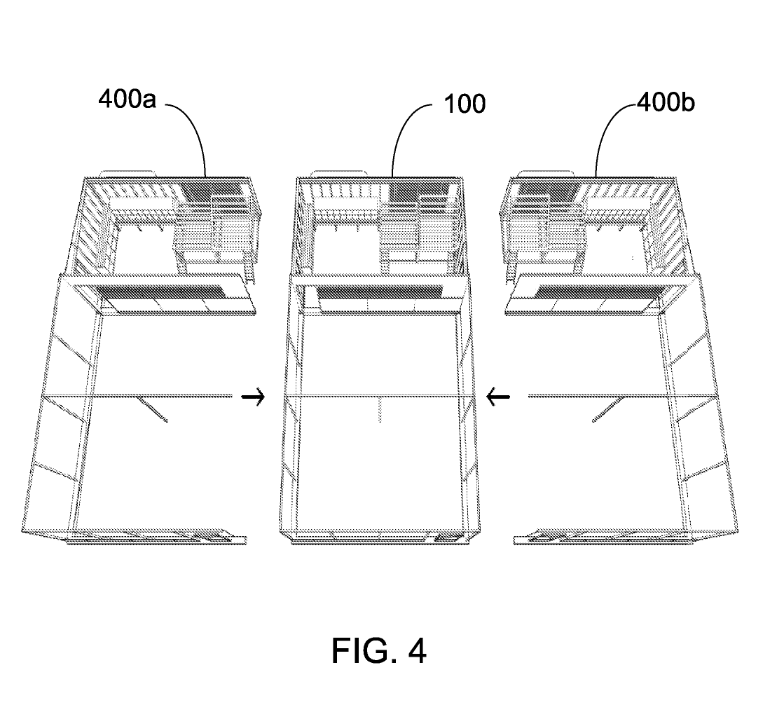

FIG. 4 shows an overhead view of an expandable chicken garden in accordance with the present invention. Chicken gardens 400a and 400b can be coupled to chicken garden 100 to increase the enclosed size and capacity of the chicken garden. Chicken gardens 400a and 400b can use the existing sides 206 and frame 114 of chicken garden 100, reducing the overall cost of expanding the chicken garden.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A system for housing laying hens, comprising:
a covered structure having a roof;
a perching structure within the covered structure, the perching structure providing a place for the hens to rest off the ground;
a worm region below the perching structure for worms to process manure from the hens on the perching structure;
a nesting area within the covered structure, the nesting area providing multiple nesting boxes for nesting hens;
a door in the covered structure behind the perching structure providing access to remove worm castings from the worm region;
fencing supports for supporting fencing in a yard area that is outside of the covered structure and is accessible to the hens;
a door for selectively providing or denying the hens access to the yard area from the covered building.

2. A system in accordance with claim 1, further comprising a yard area including a grain crop for feeding the laying hens.

3. A system in accordance with claim 1, further comprising a rainwater collection for collecting rainwater that falls on the roof of the covered structure.

4. A system in accordance with claim 1, further comprising an irrigation system for irrigating the yard area.

5. A system in accordance with claim 3, further comprising an irrigation system for irrigating the yard area using water from the rainwater collection system.

6. A system in accordance with claim 1, in which the rainwater collection system comprises a gutter on the covered structure and a rainwater storage tank.

7. A system in accordance with claim 1, further comprising fencing supported by the fencing supports, the fencing covering the sides and top of the yard area to protect the laying hens from predators.

8. A system in accordance with claim 1, further comprising worms in the worm region.

9. A system for housing laying hens, comprising multiple connected systems in accordance with claim 1.

10. A kit for housing poultry, comprising instructions for assembling housing for laying hens and a combination of structural members which when assembled in accordance with the instructions form:
a covered structure having a roof,
a perching structure within the covered structure, the perching structure providing a place for the poultry to rest off the ground;
a worm region below the perching structure for worms to process manure from the chickens on the perching structure;
a nesting area within the covered structure, the nesting area providing multiple partitions for nesting hens;
a door in the covered structure behind the perching structure providing access to remove worm castings from the worm region;
a frame for supporting fencing for fencing a yard area that is outside of the covered structure and is accessible to the hens; and
a door for selectively providing or denying the poultry egress from the covered building.

11. A kit in accordance with claim 10, wherein the combination of structural members, when assembled in accordance with the instructions, further forms a rainwater collection system for collecting rainwater that falls on the roof of the covered structure.

12. A kit in accordance with claim 10, wherein the combination of structural members, when assembled in accordance with the instructions, further forms an irrigation system for irrigating the yard area.

13. A kit in accordance with claim 11, wherein the combination of structural members, when assembled in accordance with the instructions, further forms an irrigation system for irrigating the yard area using water from the rainwater collection system.

14. A kit in accordance with claim 10, in which the rainwater collection system comprises a gutter on the covered structure and a rainwater storage tank.

15. A kit in accordance with claim 10, wherein the combination of structural members, when assembled in accordance with the instructions, further forms fencing supported by the fencing supports, the fencing covering the sides and top of the yard area to protect the laying hens from predators.

16. A kit in accordance with claim 10, further comprising worms in the worm region.
